(19) United States
(12) Patent Application Publication
(10) Pub. No.: US 2019/0265575 A1
(43) Pub. Date: Aug. 29, 2019

(54) APPARATUS FOR AUTO FOCUS WITH IMPROVED STOPPER STRUCTURE

(71) Applicant: JAHWA ELECTRONICS CO., LTD., Chungcheongbuk-do (KR)

(72) Inventors: Jae Yong GO, Seoul (KR); Byung Cheol LEE, Gyeongsangnam-do (KR); Hwan Hwi LEE, Chungcheongbuk-do (KR)

(21) Appl. No.: 16/266,625

(22) Filed: Feb. 4, 2019

(30) Foreign Application Priority Data
Feb. 28, 2018 (KR) 10-2018-0024529

(51) Int. Cl. G03B 13/36; G02B 13/00; G02B 7/10; H04N 5/225; H04N 5/232

(52) U.S. Cl. CPC G03B 13/36; G02B 13/001; H04N 5/23212; H04N 5/2254; G02B 7/102

(57) ABSTRACT

An apparatus for auto focus having an improved stopper structure includes a base frame configured to give an inner space, a carrier accommodated in the base frame to move in an optical axis direction, a plurality of balls located between the base frame and the carrier, and a stopper provided at an upper portion of the carrier and having a protrusive shape to prevent the plurality of balls from deviating, the stopper allowing an uppermost ball among the plurality of balls to be partially exposed.

### CROSS-REFERENCE TO RELATED APPLICATION AND CLAIM OF PRIORITY

This application claims priority to Korean Patent Applications No. 10-2018-0024529 filed on Feb. 28, 2018 in the Korean Intellectual Property Office (KIPO), the entire disclosure of which is incorporated by reference herein.

### TECHNICAL FIELD

The present disclosure relates to an apparatus for auto focus, and more particularly, to an apparatus for auto focus with an improved stopper structure for preventing balls from deviating.

### BACKGROUND ART

As the hardware technology for image processing has been developed and the user needs for image shooting have increased, functions such as autofocus (AF) and optical image stabilization (OIS) have been applied to a camera module or the like, mounted to a portable terminal such as a cellular phone and a smart phone as well as an independent camera device.

The auto focus function is to adjust a focus distance to a subject by linearly using carrier having a lens or a lens in an optical axis direction so that a clear image is generated at an image sensor (CMOS, CCD or the like) provided at a rear end of the lens.

Generally, a ball or a ball bearing 53 is used in an AF device 50 to guide the linear movement of a carrier 51. The ball 53 is in line contact or point contact with a housing 52 and the carrier 51, respectively, to give a minimized frictional force, and also gives physical behavior characteristics due to rolling or moving thereof to guide the carrier 51 to more flexibly move forward and backward in an optical axis direction (a Z-axis direction).

Conventionally, the ball 53 having a sufficiently large diameter may be used, so that the ball 53 may be prevented from deviating out due to an outer housing or a case 58 even though a means for preventing deviation of the ball 53 (a stopper) is not provided at the carrier 51. In addition the movement of the carrier 51 in the optical axis direction may be sufficiently supported and guided by the ball 53.

However, if the AF device 50 is designed slimmer and lighter, the diameter of the ball 53 provided inside the AF device 50 must also be reduced. Thus, the ball 53 may deviate into the space between the outer housing 58 and the carrier 51 (or, the space where the carrier moves). In addition, a portion for the point contact between the ball 53 and the carrier 51 may not be sufficiently secured, so that the carrier 51 may be tilted during AF operation.

Further, in order to solve this problem, there is also disclosed a technique in which the stopper 55 is provided at an upper portion of the carrier 51 to secure sufficient point contact support between the ball 53 and the carrier 51 so that the ball 53 does not deviate to the outside, even though the carrier 51 moves in the optical axis direction, as shown in FIG. 1.

However, in this case, the carrier 51 is not able to move as much as the thickness of the stopper 55, and thus the moving distance according to the AF operation of the carrier 51 is reduced to D1, thereby degrading the precision and efficiency of the AF operation.

Further, in the conventional AF device 50, the stopper 55 is entirely protruded out, and thus it is impossible to introduce the ball 53 inward from the outside. For this reason, there is needed an inverse process in which the ball 53 is located at the housing 52 or the carrier 51 by tilting the housing 52 and then the carrier 51 is coupled to the housing 52 in this state.

Thus, the ball 53 having a small diameter may not be held in place, the ball may be deviated or lost, and the efficiency of the assembling process may become extremely low.

### SUMMARY

The present disclosure is designed to solve the problems of the related art, and therefore the present disclosure is directed to providing an apparatus for auto focus, which may prevent a ball from deviating out and further improve the efficiency of an assembling process without causing a tilting problem during the AF operation, by improving the structure of a stopper provided at a carrier.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

In one aspect of the present disclosure, there is provided an apparatus for auto focus having an improved stopper structure, comprising: a base frame configured to give an inner space; a carrier accommodated in the base frame to move in an optical axis direction; a plurality of balls located between the base frame and the carrier; and a stopper provided at an upper portion of the carrier and having a protrusive shape to prevent the plurality of balls from deviating, the stopper allowing an uppermost ball among the plurality of balls to be partially exposed.

Also, the carrier of the present disclosure may have a first guiderail formed to extend in the optical axis direction, and in this case, the plurality of balls may be located at the first guiderail and the stopper may be provided at an upper portion of the first guiderail.

In an embodiment, the base frame of the present disclosure may have a second guiderail formed corresponding to the first guiderail, and in this case, the plurality of balls may be located between the first and second guiderails.

Also, the stopper of the present disclosure may allow an upper portion of the uppermost ball to be exposed.

Preferably, the apparatus for auto focus according to the present disclosure may further comprise a driving magnet provided at the carrier; a driving coil provided at the base frame to generate an electromagnetic force to the driving magnet; and an auto focus (AF) yoke provided at the base frame to generate an attractive force to the driving magnet.

Further, a lower surface of the stopper of the present disclosure may have a shape corresponding to a part of an upper surface of the uppermost ball.

Preferably, the stopper of the present disclosure may include a groove at which the upper portion of the uppermost ball is exposed; and a protrusive support configured to physically support the uppermost ball, and in this case, the groove may have one side opened.

According to an embodiment of the present disclosure, even though the carrier moves forward or backward in the optical axis direction based on the base frame (the housing, the stator, and so on) by the AF operation, it is possible to prevent the ball from deviating out or moving out of a predetermined region and thus incompletely supporting the carrier. In addition, even though the entire volume of the apparatus is reduced, it is possible to secure a relatively sufficient moving distance of the carrier, thereby improving the efficiency of the AF operation.

Further, in the present disclosure, a space for introducing the ball from the outside during the assembly process may be provided, and thus a plurality of balls may be more easily and simply introduced between the base frame and the carrier in a state where the carrier is assembled with the base frame (or, the housing), thereby greatly improving the efficiency of the assembling process.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram showing a structure of a conventional AF device,

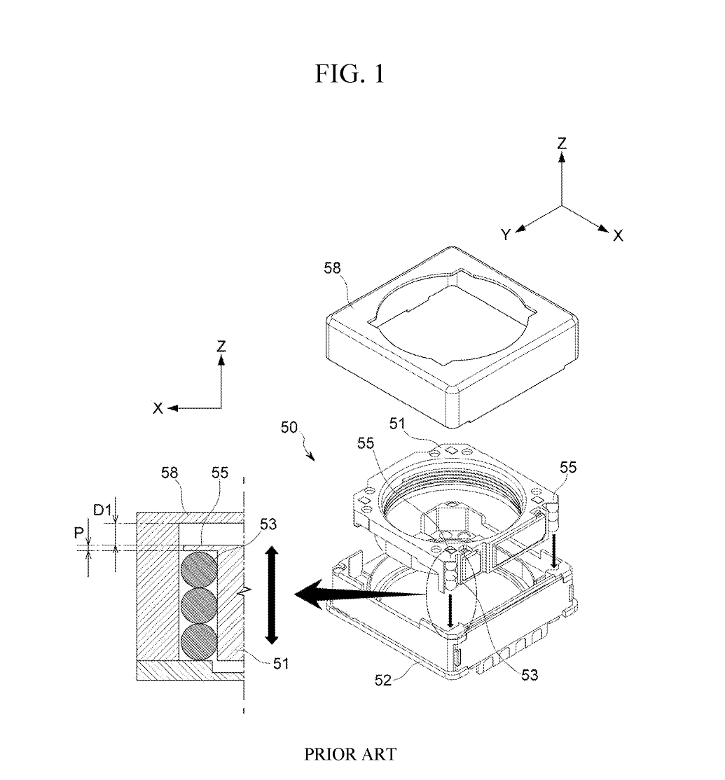

FIG. 2 is an exploded view showing an apparatus for auto focus according to an embodiment of the present disclosure,

FIG. 3 is a diagram showing a structure of a stopper of the present disclosure in detail,

FIG. 4 is a diagram showing that the AF operation distance is relatively increased due to the stopper of the present disclosure,

FIG. 5 is a diagram showing various examples of the stopper of the present disclosure, and

FIG. 6 is a schematic diagram for illustrating a process of introducing a ball according to an embodiment of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

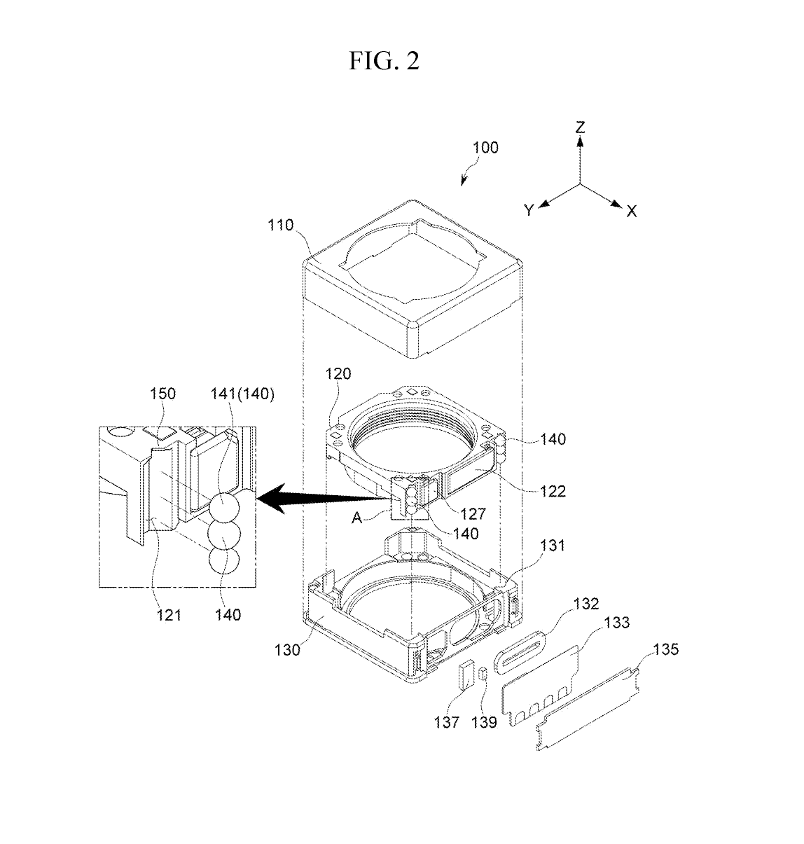

FIG. 2 is an exploded view showing an apparatus 100 for auto focus (hereinafter, also referred to as an ‘AF apparatus’) having an improved stopper structure according to an embodiment of the present disclosure,

As shown in FIG. 2, the AF apparatus 100 according to an embodiment of the present disclosure may include a shield case 110, a carrier 120, a base frame 130, a plurality of balls 140, and a stopper 150.

A lens or a lens assembly (not shown) is mounted to the carrier 120 of the present disclosure to physically move together with the carrier 120. Thus, if the carrier 120 moves in the optical axis direction (the Z-axis direction), the lens or the lens assembly also moves in the optical axis direction, and the distance to an image sensor (not shown) of CCD, CMOS or the like is adjusted through this movement, thereby implementing the auto focus (AF) function.

In a device in which AF and OIS functions are integrated, the lens may also be provided to an OIS carrier that moves in a direction (the X axis direction and Y axis direction) perpendicular to the optical axis depending on embodiments.

In an embodiment in which the AF function and the OIS function are integrated, the OIS carrier for the OIS operation moving in the X-axis and Y-axis direction perpendicular to the optical axis direction Z may be further provided.

In this case, depending on embodiments, the lens (or the lens assembly) may be mounted to the OIS carrier (not shown), and if the carrier 120 moves in the optical axis direction, the OIS carrier may also be designed to move in the optical axis direction together. As a result, the lens also moves in the optical axis direction.

The AF apparatus 100 of the present disclosure may be applied not only to a device in which the AF function is implemented singly but also to a device in which the AF function and the OIS function are integrated.

The base frame 130 of the present disclosure corresponds to the carrier 120. If the carrier 120 is a moving body for the AF operation, the base frame 130 corresponds to a stator in a relative viewpoint.

The base frame 130 is a configuration for accommodating the carrier 120 and giving an inner space in which the carrier 120 moves. The base frame 130 may include a driving coil 132, an FPCB 133, an AF yoke 135, a drive chip 137, a hall sensor 139, and the like.

The driving coil 132 generates an electromagnetic force corresponding to the intensity and direction of the power applied from the outside to move the carrier 120 having the driving magnet 122 in the optical axis direction.

The hall sensor 139 senses the position of the driving magnet 122 (the position of the carrier, namely the position of the lens) using the hall effect and transmits the corresponding signal to the drive chip 137 of the present disclosure. The drive chip 137 uses the input signal of the hall sensor 139 so that a power of suitable intensity and direction is applied to the driving coil 132.

In this way, the auto focus function is realized by feedback control of the exact location of the lens based on the optical axis direction. The driving coil 132, the drive chip 137 and the hall sensor 139 are mounted on an FPCB 133 connected to an external module, a power source, an external device or the like. Though the hall sensor 139 and the drive chip 137 are depicted in the figure as being individually provided, the hall sensor 139 and the drive chip 137 may be implemented as a single chip through the SOC or the like.

In addition, the hall sensor 139 may be configured to sense the magnetic force of the driving magnet 122 so that the location of the carrier 120 is sensed using the intensity and direction of the sensed magnetic force. Moreover, in order to improve the efficiency of sensing, the hall sensor 139 may be configured to sense the location of the carrier 120 by detecting the magnetic force of the sensing magnet 127.

As shown in FIG. 2, the plurality of balls 140 arranged in a direction corresponding to the optical axis direction are disposed between the carrier 120 and the base frame 130. By means of the plurality of balls 140, the carrier 120 and the base frame 130 are kept to be spaced apart by a distance corresponding to the diameter of the balls.

The driving magnet 122 provided at the carrier 120 and the AF yoke 135 for generating an attractive force may be provided at the base frame 130 so that the carrier 120 and the base frame 130 may keep a proper spacing and continuously maintain a point contact with the ball of the carrier 120.

As shown in FIG. 2, the stopper 150 of the present disclosure is provided at the carrier 120 that moves by the AF operation. The stopper 150 allows the balls 140 not to deviate out and also guides to effectively maintain the point contact between the ball 140 and the carrier 120 even though the carrier 120 moves based on the optical axis direction by the AF operation.

In order to more effectively implement the guiding function of the ball 140 and the linear movement of the carrier 120 in the optical axis direction, a first guiderail 121 having a shape extending along the optical axis direction may be formed at the carrier 120, and a second guiderail 131 corresponding thereto may be formed at the base frame 130. The plurality of balls 140 may be positioned between the first and second guiderails 121, 131.

The first and second guiderails 121, 131 may be formed as a groove line with a section having a V shape, a U shape, or a combination thereof to reduce the frictional force and enhance the linear mobility. However, the first and second guiderails 121, 131 may be implemented in various shapes including mutually corresponding shapes such as concave or convex shapes as long as it is possible to guide the linear movement of the carrier 120.

In addition, even though it is depicted in the figures that two first guiderails 121 and two second guiderails 131 are provided at right and left sides (based on the Y axis) on the same plane to face each other, this is only one embodiment, and the first and second guiderails 121, 131 may be provided at different surfaces and may also be provided not to face each other depending on characteristics, physical structure or the like of the apparatus, as long as it is possible to guide the movement of the carrier 120 in the optical axis direction.

Further, it is also possible that only the first guiderail 121 is formed at the carrier 120, the balls 140 are disposed between the first guiderail 121 and the base frame 130. Alternatively, it is also possible that only the second guiderail 131 is formed at the base frame 130, and the balls 140 are disposed between the carrier 120 and the second guiderail 131.

As shown in FIG. 2 or the like, the stopper 150 of the present disclosure is provided at the carrier 120 and has a protrusive shape. The stopper 150 is in contact with the plurality of balls 140, particularly an uppermost ball 141 among the plurality of balls 140 that is disposed at an uppermost portion in the optical axis direction, to prevent the uppermost ball 141 from deviating. Also, the stopper 150 is shaped to expose a part of the uppermost ball 141, preferably an upper portion of the uppermost ball 141.

As described below, the stopper 150 of the present disclosure is configured to solve the tilting problem of the carrier 120 caused by the deviation of the ball 140 to the outside or poor support, and to secure a sufficient moving distance according to the AF operation of the carrier 120. Thus, it is more preferable that the stopper 150 of the uppermost ball 141 is configured to expose the upper portion including a highest top (based on the optical axis direction) of the uppermost ball 141.

The shield case 110 of the present disclosure is coupled to the base frame 130 and corresponds to an outer case of the AF apparatus 100. The shield case 110 may be made of a magnetic material in order to enhance the effect of blocking a magnetic force from the outside.

Hereinafter, the configuration and functions of the stopper 150 of the present disclosure will be described in detail with reference to the figures.

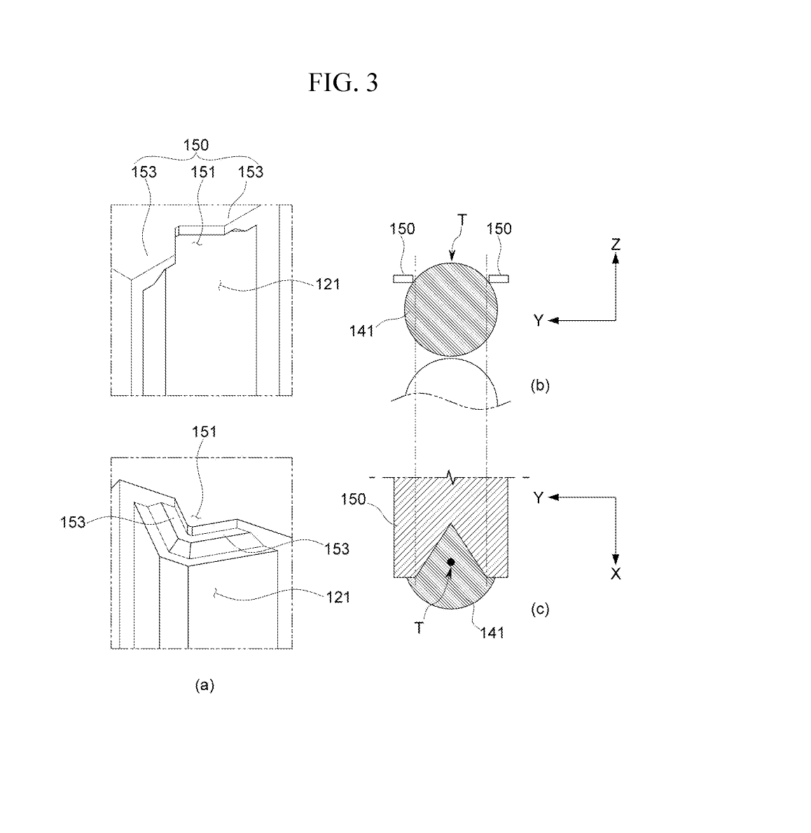

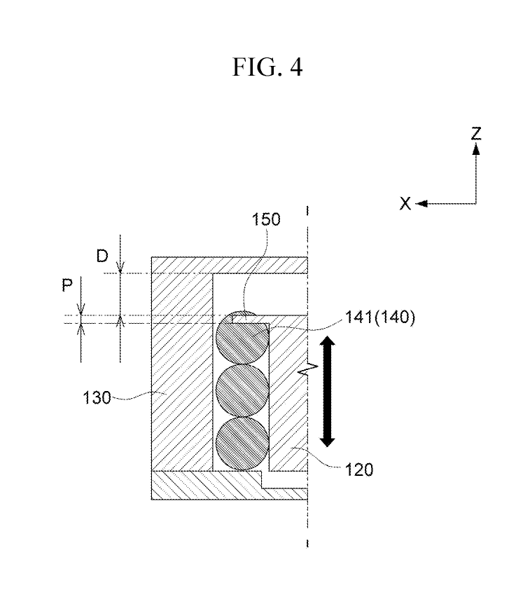

FIG. 3 is a diagram showing the structure of the stopper 150 of the present disclosure in detail, and FIG. 4 is a diagram showing that the AF operation distance is relatively increased due to the stopper 150 of the present disclosure.

As shown in (a) of FIG. 3, specifically, the stopper 150 may include a groove 151 and a protrusive support 153. The groove 151 is configured to allow the upper portion of the uppermost ball 141, preferably the top T of the upper portion, to be exposed upward based on the optical axis direction. The protrusive support 153 of the stopper 150 is in contact with the uppermost ball 141 to physically support the uppermost ball 141.

Thus, as shown in (b) of FIG. 3, the height of the uppermost portion of the stopper 150, namely the height of the uppermost portion of the carrier 120 may be equal to or lower than the top T of the upper portion of the uppermost ball 141. Also, when being observed in the planar direction as shown in (c) of FIG. 3, the top T of the upper portion of the uppermost ball 141 may be exposed through the groove 151 of the stopper 150.

A part of the upper portion of the ball 140 in contact with the stopper 150 among the plurality of balls is exposed through the groove 151, and the portion exposed through the groove 151 preferably becomes the uppermost top of the upper portion of the ball 140 in contact with the stopper 150.

In this configuration, a part of the upper portion of the ball in contact with the stopper 150 among the plurality of balls 140 is exposed to the outside in a direction toward the shield case 110 through the groove 151 of the stopper 150.

As shown in FIG. 3, if the first guiderail 121 is formed at the carrier 120, the stopper 150 of the present disclosure may be provided at the upper portion of the first guiderail 121.

If the stopper 150 of the present disclosure has a shape exposing the upper portion of the uppermost ball 141 as above, as shown in FIG. 4, the moving distance D of the carrier 120 according to the AF operation may be extended to a distance including the thickness P of the stopper 150.

Due to this structural characteristic, even though the entire height of the AF apparatus 100 is reduced, the moving distance (stroke) of the carrier 120 according to the AF operation may be relatively expanded.

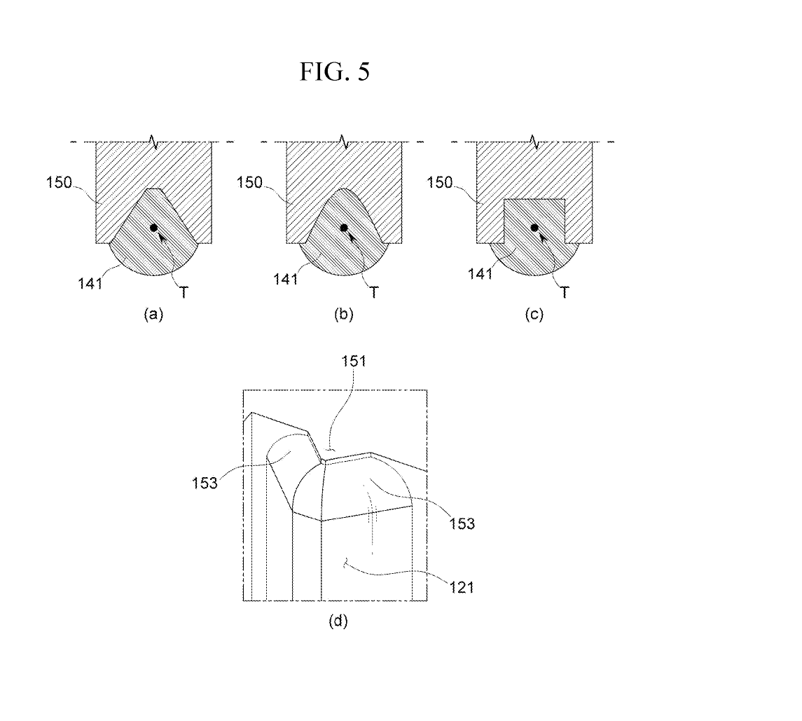

FIG. 5 is a diagram showing various examples of the stopper 150 of the present disclosure.

As shown in (a) to (c) of FIG. 5, the stopper 150 of the present disclosure may have various shapes as long as the upper portion of the uppermost ball 141 is exposed and the other portions are physically supported. Though (a) to (c) of FIG. 5 show that one side of the stopper 150 is opened, it is also possible that one side of the stopper has a ring shape with no open portion, which has a diameter smaller than the diameter of the uppermost ball 141.

In addition, in order to physically support the uppermost ball 141 and sufficiently expose the upper portion of the uppermost ball 141 upward, the stopper 150 of the present disclosure may have a tapered shape or a stepped shape to correspond to the physical shape of the uppermost ball 141.

From the corresponding viewpoint, as shown in (d) of FIG. 5, if the lower surface of the stopper 150 has a rounded shape corresponding to the upper surface of the uppermost ball 141 or a part of the upper surface of the uppermost ball 141, it is possible to realize the physical support of the uppermost ball 141 more effectively and further enhance the spatial utilization, thereby further increasing the physical moving distance according to the AF operation of the carrier 120.

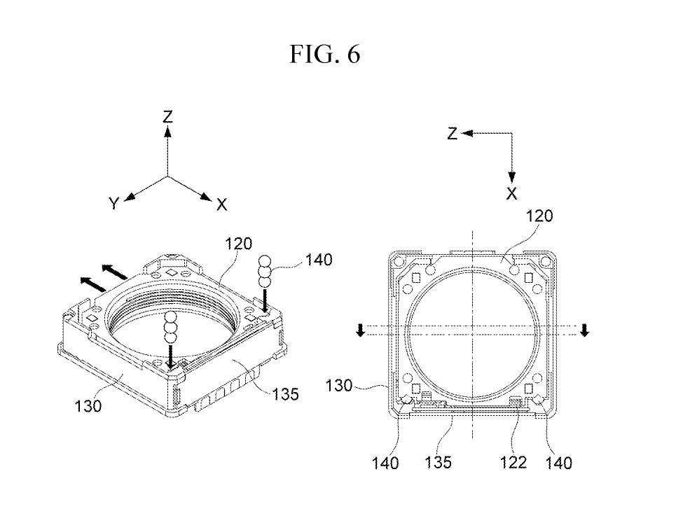

FIG. 6 is a schematic diagram for illustrating a process for introducing the balls 140 according to an embodiment of the present disclosure.

As described above, the conventional stopper has only a protrusive shape as a whole, and thus the space for introducing the balls by inserting the balls from the outside is blocked, which lowers the efficiency of the assembling process.

However, if the stopper 150 is implemented to expose the upper portion of the uppermost ball 141 and to have one side opened, as shown in the left side of FIG. 6, just by slightly moving the carrier 120 backward (based on FIG. 6 in the −X-axis direction), a sufficient space for introducing the balls 140 may be secured.

Thus, after the carrier 120 is coupled to the base frame 130, the coupled carrier 120 is moved slightly rearward by utilizing space clearance or the like to maintain its location, and then the balls may be easily and simply introduced into the space between the carrier 120 and the base frame 130.

If the stopper 150 of the present disclosure is formed at the upper portion of the first guiderail 121 and the second guiderail 131 is formed at the base frame 130 as described above, after the carrier 120 is slightly moved backward, the balls 140 may be easily introduced into the space between the first and second guiderails 121, 131 through the space secured in the opened region of the stopper 150.

In this configuration, the first and second guiderails 121, 131 are spaced apart slightly further, compared to the assembled form, and the space between the first and second guiderails 121, 131 naturally gives a space for preventing the balls 140 from being deviated or lost. Thus, the balls may be easily introduced without a delicate work, and it is possible to fundamentally prevent the problem that the balls 140 are lost or deviated out of place while being introduced.

If the balls 140 are completely introduced, the carrier 120 is moved backward to remove the external force that maintains its position. If so, the carrier 120 moves naturally forward due to the attraction force between the driving magnet 122 provided at the carrier 120 and the AF yoke 135 provided at the base frame 130, and thus the coupling process may be simply completed.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first”, “second”, “upper” and “lower” are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An apparatus for auto focus having an improved stopper structure, comprising:
a base frame configured to give an inner space;
a carrier accommodated in the base frame to move in an optical axis direction;
a plurality of balls located between the base frame and the carrier; and
a stopper provided at an upper portion of the carrier and having a protrusive shape to prevent the plurality of balls from deviating, the stopper allowing an uppermost ball among the plurality of balls to be partially exposed.

2. The apparatus for auto focus having an improved stopper structure according to claim 1, wherein the carrier has a first guiderail formed to extend in the optical axis direction; and
the plurality of balls are located at the first guiderail, and the stopper is provided at an upper portion of the first guiderail.

3. The apparatus for auto focus having an improved stopper structure according to claim 2, wherein the base frame has a second guiderail formed corresponding to the first guiderail; and
the plurality of balls are located between the first and second guiderails.

4. The apparatus for auto focus having an improved stopper structure according to claim 1, wherein the stopper allows an upper portion of the uppermost ball to be exposed.

5. The apparatus for auto focus having an improved stopper structure according to claim 1, further comprising:
a driving magnet provided at the carrier;
a driving coil provided at the base frame to generate an electromagnetic force to the driving magnet; and
an auto focus (AF) yoke provided at the base frame to generate an attractive force to the driving magnet.

6. The apparatus for auto focus having an improved stopper structure according to claim 1, wherein a lower surface of the stopper has a shape corresponding to a part of an upper surface of the uppermost ball.

7. The apparatus for auto focus having an improved stopper structure according to claim 4, wherein the stopper includes:
a groove at which the upper portion of the uppermost ball is exposed; and
a protrusive support configured to physically support the uppermost ball.

8. The apparatus for auto focus having an improved stopper structure according to claim 7, wherein the groove has one side opened.
